(19) United States
(12) Patent Application Publication
(10) Pub. No.: US 2024/0278981 A1
(43) Pub. Date: Aug. 22, 2024

(54) SHIPPING CONTAINER SYSTEM WITH INTEGRATED RECHARGEABLE BATTERY

(71) Applicant: Smyrna Technologies, LLC, Lewes, DE (US)

(72) Inventor: Wanseok Song, Smyrna, GA (US)

(21) Appl. No.: 18/576,039

(22) PCT Filed: Jul. 6, 2022
(86) PCT No.: PCT/US2022/036270

§ 371 Date: Jan. 2, 2024

Related U.S. Application Data
(60) Provisional application No. 63/218,703, filed on Jul. 6, 2021.

(51) Int. Cl. B65D 88/74; B63B 17/00; B63H 21/38; H02S 10/20; H02S 20/30

(52) U.S. Cl. CPC B65D 88/744; B63B 17/0027; B63H 21/38; H02S 10/20; H02S 20/30

(57) ABSTRACT

A container adapted to hold a power source, is described. The container includes a plurality of frame elements defining a plurality of corners and sides of the container. The plurality of frame elements define an interior adapted for receiving the power source and an exterior disposed of in an environment in which the container is placed. At least one power source is located in the interior and a plurality of electrical connections provided on the exterior. The electrical connections provide for connectivity to the power source. Interconnected containers are also described.

This application claims priority as a non-provisional of U.S. provisional filing 63/218,703 filed on Jul. 6, 2021, presently pending, the contents of which are incorporated by reference.

### FIELD OF THE INVENTION

This disclosure relates to a system for using shipping containers (or intermodal cargo containers) that are loaded onto large marine vessels, or cargo ships, for transport across bodies of water. The disclosure is related in particular to a system utilizing containers with onboard batteries which provide power to an electrically powered cargo ship.

### BACKGROUND OF THE INVENTION

Large cargo ships carrying large shipping containers are the primary method of transporting bulk goods across oceans and seas. Each of these ships can carry thousands of containers that typically measure either twenty or forty feet in length. There are thousands of such ships in operation and as the volume of goods shipped continues to increase, so does the number of ships. These large container ships are generally powered by diesel engines, which like most combustion engines, emit pollutants harmful to the environment. Thus, the container shipping industry is beginning to transition to ships driven by electric motors which emit minimal emissions.

An electric container ship relies on built-in onboard batteries to provide it with a reliable source of power. As an electric container ship traverses along its route, the power remaining in these batteries is depleted. The electric container ship must then recharge these batteries after arriving at its port of destination. This limits the ports at which the ship can recharge its batteries as the port must be equipped with a charging station that is compatible with the electrical system used on that particular ship. This recharging process is also time-consuming as the ship must remain docked until the process is completed. This reduces the amount of time the ship is available for transport and increases costs to the shipping operator. An electric container ship relying on its built-in onboard batteries additionally makes it difficult to replace the batteries as necessary due to degradation or damage. As battery technology continues to progress, more efficient batteries are readily becoming available. Upgrading the built-in onboard batteries on an electric container ship can be difficult, and in some cases, impossible.

It would be desirable to provide a method of providing portable power to an electric container ship that does not require the ship to remain docked at a port containing a charging station that can supply it with power. This alternate method of providing power to an electric container ship should reduce the amount of time required for the ship to remain docked for the purpose of recharging its batteries. As the containers transported by container ships and the equipment used to load, unload as well as transport the ships by lands are all highly standardized, this method must also preserve the dimensions of the container to allow it to be used with all standardized equipment currently in use. It would also be desirable for this method to allow more flexible and lower-cost modifications and upgrades to an electric ship's power systems to continue to take advantage of the continuing advances in battery technology.

Accordingly, there remains a need in the art for a method of providing portable power to an electric container ship that reduces the turnaround time required to replenish the power supply of the ship and provides for increased flexibility in making modifications to the systems used to supply portable power to the ship.

### SUMMARY OF THE INVENTION

The present invention addresses the problems identified above by providing a rechargeable battery shipping container with onboard batteries that can be used to power an electric container ship. By utilizing shipping containers with onboard batteries, the time required for an electric container ship to recharge can be reduced or eliminated, and the difficulty in replacing, upgrading, or augmenting batteries that power an electric container ship can be reduced. The rechargeable shipping container preserves the dimensions of a standard intermodal cargo shipping container which allows it to be used with all standardized equipment to load and unload the containers such as overhead cranes, trains, aircraft, and tractor-trailers.

The rechargeable shipping container also contains electrical connection points of contact which can be electrically connected to systems for providing power to a transportation ship or other vehicle as well as receiving power that is stored in the rechargeable batteries contained within the rechargeable shipping container. The rechargeable shipping container can also be used to supply power to fixed structures such as houses or buildings or other land equipment such as construction equipment. The electrical points of contact also permit the rechargeable shipping container to be connected to other shipping containers to increase the capacity, current draw, and/or voltage provides to the power systems of the vehicle.

In accordance with one embodiment of the invention, the rechargeable shipping container comprises a standard intermodal cargo container with a primary compartment for placing goods to be transported, and a secondary compartment containing batteries that supply power to the electric container ship.

In accordance with another embodiment of the invention, the rechargeable shipping container comprises a standard intermodal cargo container with a single compartment that consists entirely of battery packs that supply power to the electric container ship.

In accordance with another embodiment of the invention, the rechargeable shipping container comprises a standard intermodal cargo container with a single compartment that consists entirely of a power generation system such as a collapsible wind turbine or hydrogen-powered fuel cell which supplies power to the electric container ship.

In accordance with another embodiment of the invention, the rechargeable shipping container comprises a standard intermodal cargo container with a primary compartment containing batteries that supply power to the electric container ship, and a secondary compartment containing a power generation system such as a collapsible wind turbine or hydrogen-powered fuel cell which supplies power to the electric container ship.

In accordance with another embodiment of the invention, the rechargeable shipping container comprises a standard intermodal cargo container with a primary compartment for placing goods to be transported, and a secondary compartment containing batteries that supply power to the electric container ship, and solar panels installed on the external sides, ends or roof of the shipping container.

In accordance with another embodiment of the invention, the rechargeable shipping container comprises a standard intermodal cargo container that contains rechargeable batteries which can supply power to multiple electric vehicles including container ships, container trucks, trains, or aircraft.

In accordance with another embodiment of the invention, the rechargeable shipping container comprises a standard intermodal cargo container that contains rechargeable batteries which can supply power to stationary structures such as buildings, houses, or temporary shelters.

Various elements of the invention may be used alone or in combination. Numerous aspects of the present invention are herein presented.

There are other aspects, features, and advantages of the present invention that will become more readily apparent from the attached drawings and the detailed description of the preferred embodiments, which follow.

### BRIEF DESCRIPTION OF THE DRAWINGS

FIG. 1 presents a representative isometric view of a standard intermodal shipping container.

FIG. 2 presents representative side-facing and front-facing views of a rechargeable shipping container depicting primary compartments for cargo and secondary compartments for batteries.

FIG. 3 presents a representative isometric view of the rechargeable shipping container depicting the placement of power outlets.

FIG. 4 presents a representative isometric cutaway view of a rechargeable shipping container depicting the frame of the container and an internal compartment for batteries.

FIG. 5 presents a representative isometric view of a rechargeable shipping container with solar panels affixed to the roof and side in a raised position.

FIGS. 6A-B present representative diagrams of the placement of power outlets within the frame of the rechargeable shipping container.

FIG. 7 presents a representative diagram of a number of rechargeable shipping containers connecting in parallel to the power drive system of a ship.

FIG. 8 presents a representative diagram of a number of rechargeable shipping containers connecting in series to the power drive system of a ship.

FIG. 9 presents an alternative arrangement of containers.

FIG. 10 presents a depiction global heat flow gradients.

FIG. 11 is a cut-away view of one embodiment of a wall of a container.

FIG. 12 is a schematic depiction of an application of a power source container providing power to recipient devices.

FIGS. 13A-E are a schematic depiction of power sources for containers.

FIGS. 14A-C depict an alternative embodiment showing a moving container.

FIGS. 15A-C depict a solar panel module added to a container, pursuant to an embodiment of the invention.

FIGS. 16A-D depict a locking mechanism for a solar panel, pursuant to an embodiment of the invention.

FIG. 17 depicts a top view of a container with batteries, pursuant to an embodiment of the invention.

FIG. 18 depicts a further embodiment of the invention having additional air movement devices.

FIG. 19 depicts a schematic overview of an embodiment designed to assist in the propulsion of the vessel.

FIG. 20 depicts an overview of additional embodiments of the device showing a supplemental battery.

FIG. 21 depicts several applications of a supplemental battery.

### DETAILED DESCRIPTION OF THE INVENTION

A rechargeable intermodal cargo container is illustrated in various configurations in the figures. The invention is described in terms of its usage on a cargo ship, but it can be used to provide power to any number of vehicles including other ships such as cruise liners, oil tankers, naval ships, or other transport vehicles such as electric trains, electric trucks, or electric aircraft. Descriptions of the invention in the context of a cargo ship should not be construed to limit the invention to use on cargo ships.

The rechargeable shipping container provides power to the electrical ship or vehicle transporting the shipping container via batteries installed onboard the container. The onboard batteries will occupy a portion of the internal volume of a standard shipping container while the remainder of the internal volume will be designated for cargo. Each rechargeable shipping container contains electrical contacts which allow the container to be connected to a power drive system or a power recharging system. Additionally, the containers, via the electrical contact points, can be connected to each other in parallel or in series, allowing two or more rechargeable shipping containers to be recharged simultaneously or provide levels of current, voltage, or power capacity beyond that of a single rechargeable container.

As batteries are installed within the shipping container, the rechargeable shipping container permits electric container ships to be loaded and unloaded using standard processes with only minor modifications. Cargo containers are unloaded from the ship contain depleted batteries which are connected to a charging station for recharging. Cargo containers that are loaded onto the ship contained charged batteries to supply power to the ship. In this manner, the power supply of the cargo ship can be replenished simultaneously via the standard unloading and loading of containers.

In some embodiments of the invention, the shipping containers can contain a power generation system that converts solar, wind, or hydrogen fuel cell energy to electrical power. This electrical power can be routed to the electric ship's power drive systems and provide power to the ship. In embodiments where a solar or wind power generation system is used, these containers can be used as conditions permit while the electrical cargo ship is in transport. Additionally, containers containing solar and wind power generation systems would need to be placed in specific configurations within the container stack on a cargo ship to ensure adequate exposure to the wind and the sun. In one embodiment of the invention, the rechargeable shipping container can contain both a power generation system as well as onboard batteries. In this embodiment, the power generation system can serve to top up the power of the onboard batteries as required, while the batteries continue to provide power to the electric container ship while in transport.

In another embodiment of the invention, the rechargeable shipping containers can contain batteries that occupy the entire internal volume of a shipping container. While such a configuration would not permit cargo to be transported in the same container, this embodiment of the invention can simplify the loading and unloading operations of an electric container vehicle. By limiting the power source of an electric container ship to a small number of containers rather than the numerous rechargeable containers that are also carrying cargo, the power requirements of an electric container ship for a particular voyage can be more easily managed. Monitoring of an electric container ship's power source can also be more easily managed as only a small number of containers need to be monitored. The smaller number of containers providing power also reduces the number of electrical connections between the shipping containers which reduces the probability of failure among one of the electrical connections.

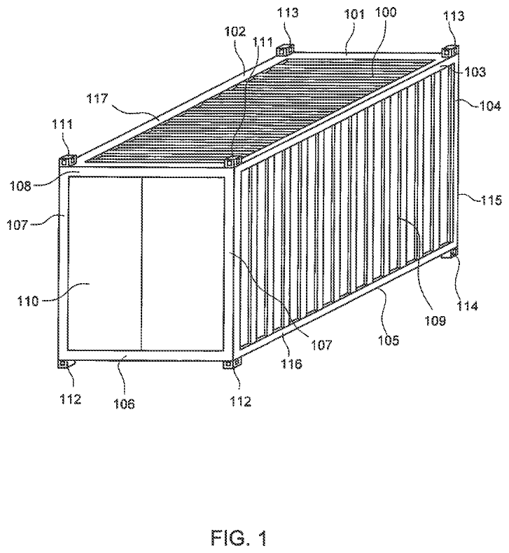

The rechargeable shipping container is designed to adhere to standards established by the International Standards Organization (ISO) for a standard intermodal shipping container as shown in FIG. 1. For example, these containers are most commonly available in 20′×8′×8′6″ (one TEU), 40′×8′×8′6″ (two TEU), and 40′×8′×9′6″ (highcube) sizes. ISO standards, such as ISO 668, have been set for shipping containers by the International Maritime Organization. These standards provide more consistent loading, transporting, and unloading of goods in ports throughout the world, allowing for saved time and resources. These standards define a number of characteristics, including external dimensions of the shipping container, referenced as a length L, a width W, and a height H. However, a person of ordinary skill in the art will understand that the containers of the present invention are not limited to these standards and that other dimensions that are not included in the standards are also possible.

The structural support for the container is provided by the container frame. The container frame is detailed in FIG. 1. The sides of the shipping container can be referenced by the following: a container cargo-access end 110, a container front-end 104, a container curb side 109, a container road-side 102, a container top 100, and a container bottom 105. The container frame is rectangular shaped in accordance with the ISO standards. The container frame comprises eight (8) corner fittings 111, 112, 113, 114, wherein the eight (8) corner fittings, define the overall dimensions of the shipping container. Although the figures show the corner fittings 111, 112, 113, 114 to be protruding from the corner posts 107, 115, that is for illustrative purposes only and they may be built or integrated into the corner posts 107, 115, forming the end portions of the corner posts 107, 115. Furthermore, while the corner fittings 111, 112, 113, 114 are located on the intersections of the frame members, in some embodiments, additional fittings (not shown) are embedded in along the lengths of the frame.

A corner post 107, 115 is provided between each bottom corner fitting 112, 114, and its respective top corner fitting 111, 113, defining each vertical segment of the container frame. Top corner fitting 111, 113 has a different aperture configuration than bottom corner fitting 112, 114, in one embodiment, as will be discussed below. A bottom cargo-access end frame rail 106 spans between each cargo-access end base corner fitting 112 defining a bottom cargo-access end frame rail 106 acting as a doorsill. A top cargo-access end frame rail 108 is assembled spanning between each cargo-access end top corner fitting 111 defining the top cargo-access end frame rail 108 acting as a door header. Collectively, the pair of cargo-access end corner posts 107, the bottom cargo-access end frame rail 106, the top cargo-access end frame rail 108, the pair of cargo-access end base corner fittings 112, and the pair of cargo-access end top corner fittings 111 define a cargo-access end frame portion 110 of the container frame.

A bottom front-end frame rail (hidden from the view in FIG. 1) is assembled spanning between each front-end base corner fitting 114, providing front-end support for the flooring. A top front-end frame rail 101 is assembled spanning between each front-end top corner fitting 113, providing front-end support for the roof panel assembly. Collectively, the pair of front-end corner posts 115, the bottom front-end frame rail, the top front-end frame rail 101, the pair of front-end base corner fittings 114, and the pair of front-end top corner fittings 113 define a front-end frame portion 104 of the container frame.

A bottom curb-side rail 116 is assembled between the curb-side cargo-access end base corner fitting 112 (the right end base corner fitting 112 in FIG. 1) and the respective curb-side front-end base corner fitting 114 (the right front-end base corner fitting 112 in FIG. 1) providing longitudinal support for the bottom flooring. Likewise, a top curb-side rail 103 is assembled between the curb-side cargo access end top corner fitting 111 (the right cargo access end top corner fitting 111 in FIG. 1) and the respective curb-side front-end top corner fitting 113 (the right front end top corner fitting 113 in FIG. 1), providing longitudinal support for the roof panel assembly. Collectively, the curb-side cargo-access end corner post 107, the bottom curb-side rail 116, the curb-side front-end corner post 115, the curb-side top frame rail 103, and the four curb-side corner fittings 111, 112, 113, 114 define a curb-side frame portion 109 of the container frame.

Likewise, a bottom road-side rail (hidden from the view in FIG. 1) is assembled between the road-side cargo-access end base corner fitting 112 (the left cargo-access end base corner fitting 112 in FIG. 1) and the respective front-end base corner fitting (hidden from the view in FIG. 1), providing longitudinal support for the bottom flooring. A top road-side rail 117 is assembled between the road-side cargo-access end top corner fitting 111 (the left cargo access end top corner fitting 111 in FIG. 1) and the respective road-side front-end top corner fitting 113 (the left front-end corner fitting 113 in FIG. 1), providing longitudinal support for the roof panel assembly. Collectively, the road-side cargo-access end corner post 107 (the left cargo access end corner post 107 in FIG. 1), the bottom road-side rail (hidden from the view in FIG. 1), the top road-side rail 117, and road-side front end corner post (hidden from the view in FIG. 1), and the four road-side corner fittings 111, 112, 113, 114 define a road-side frame portion 102 of the container frame.

Collectively, the bottom cargo-access end frame rail 106, the bottom front-end frame rail (hidden from the view in FIG. 1), the bottom curb-side rail 116, and the bottom road-side rail (hidden from the view in FIG. 1) define a bottom flooring frame portion 105 of the container frame. Collectively, the top cargo-access end frame rail 108, the top front-end frame rail 101, the top curb-side rail 103, and the top road-side rail 117 define a container top 100 or a roof frame portion 100 of the container frame.

The container is enclosed by assembling paneling to the respective frame portions. Sidewall panels are assembled to the curb-side frame portion and road-side frame portion of the container frame enclosing each side of the shipping container. A front-end panel is assembled to the front-end frame enclosing the front-end of the shipping container. The sidewall and front-end panels can be supported by incorporating any suitable design, including a corrugated panel formation, integration of a plurality of spatially arranged sidewall panel reinforcing columns, and the like. The bottom flooring is assembled to the flooring frame portion of the container frame enclosing the bottom of the shipping container. Having said the preceding, a person of ordinary skill in the art in container manufacturing will readily understand various methods of building suitable container frames of this invention not limited to the preceding, including foldable containers and other various types of containers in addition to a conventional container described in the preceding paragraphs.

The bottom flooring frame portion 105, the roof frame portion 100, and any of four corner posts 107, 115 of a rechargeable shipping container may contain a power conduit within the structure of the posts or rails. The power conduit will contain electrically shielded wiring 302, 303 which will allow for electrical contact points placed anywhere on the external frame of the rechargeable shipping container to be electrically coupled with another container, drive system, or charging station.

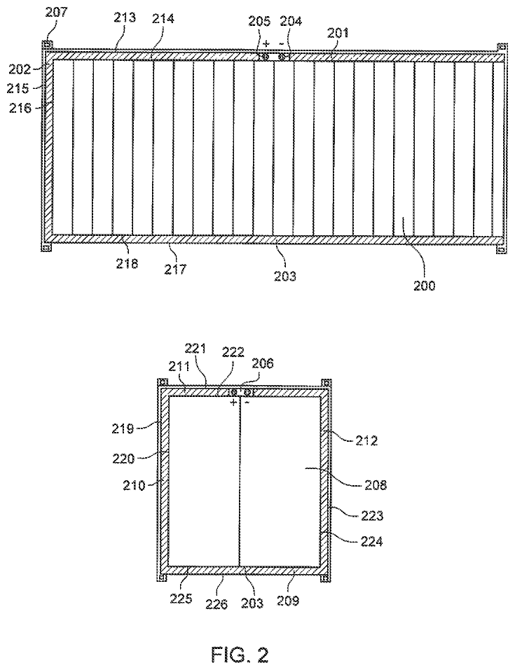

In some embodiments, the rechargeable shipping container comprises an ISO standard container with a primary compartment 200 and secondary compartments 201, 202, 203 as shown in FIG. 2. The primary compartment 200 is designated for cargo while the secondary compartments 201, 202, 203, 210, 212 house the rechargeable batteries. As the container contains an onboard power source, the container can be used as any storage space needing electric power, such as a mobile cold storage reefer container after installing a refrigeration system and insulation in the primary compartment 200.

In one such embodiment, the rechargeable shipping container comprises an ISO standard container with a primary compartment 200 and one or more secondary compartments 201, 202, 203. The primary compartment 200 is designated for cargo while one or more secondary compartments house the rechargeable batteries. The primary compartment 200 is defined by the secondary flooring 218, a secondary road-side panel 220, a secondary curb-side panel 224, the front-end panel 216, the cargo-access doors 208, and the secondary roof assembly 214. The roof panel assembly 213 includes a corner fitting 207. Like described above, the corner fitting 207 is shown to protrude from the roof panel assembly 213, but that is only for illustrative purposes only and the corner fitting 207 may be built or integrated into the secondary compartments 201, 202, 203. The cargo-access doors 208 are surrounded by a frame having side members defined by a secondary road-side panel 220 along with a secondary curb-side panel 224 a top member 211. The container also includes a container top 221 and cargo door boundary 222 and 225 adapted to be received by the frame.

In some embodiments, an interior or secondary floor compartment 203 defines the bottom flooring of the shipping container 217, the road-side panel 219, the curb-side panel 223, the front-end panel 215, the cargo-access doors 208, and a secondary flooring 218. In some embodiments, the secondary flooring 218 is supported by a secondary interior spacing frame which is comprised of an intermediate curb-side rail, an intermediate road-side rail, an intermediate front-end rail, and an intermediate cargo-access rail. The intermediate cargo-access rail extends from the corner posts on either side of the cargo-access end and is not fixed to the cargo-access doors 208. In this way, the secondary interior spacing frame supports the secondary flooring 218. The intermediate curb-side rail, an intermediate road-side rail, an intermediate front-end rail, and an intermediate cargo-access rail are located in the secondary floor compartment 203 and are not visible in the drawings. The cargo-access panel 209 is assembled to the intermediate cargo-access rail, the bottom cargo-access rail, and the corner posts on either side of the cargo-access end. This panel shields the secondary compartments when the cargo-access doors 208 are opened, and so sides of compartments 201, 203, 210, 212 are not accessible when the cargo doors 208 are opened.

The secondary frame is placed at some point between the bottom flooring frame and the roof frame of the container, depending on the space allocation between primary and secondary compartments. The face of the secondary flooring 218 is parallel to the bottom flooring 217 as well as the roof panel assembly 213. The secondary floor compartment 203 may be reinforced by a plurality of spatially arranged reinforcing columns spaced at intervals within the secondary compartment to support cargo place on top of the secondary flooring. These columns extend from the top side of the bottom flooring to the underside of the secondary flooring.

A secondary road-side compartment can be defined by the bottom flooring 226 of the shipping container, the road-side panel 219, a secondary road-side panel 220, the front-end panel 215, the cargo-access doors 208, and the roof assembly 213. The secondary road-side panel 220 is supported by a secondary road-side frame which is comprised of a secondary top road-side rail, a secondary bottom road-side rail, a first cargo-access post, and a first front-end post, not depicted in the figure.

A secondary curb-side compartment 212 can be defined by the bottom flooring of the shipping container 226, the curb-side panel 223, a secondary curb-side panel 224, the front-end panel 215, the cargo-access doors 208, and the roof assembly. The secondary road-side panel is supported by a secondary road-side frame which is comprised of a secondary top curb-side rail, a secondary bottom curb-side rail, a second cargo-access post, and a second front-end post, not depicted in the figure.

A secondary front-end compartment 202 can be defined by the bottom flooring of the shipping container 217, the front-end panel 215, a secondary front-end panel 216, the road-side panel 219, the curb-side panel 223, and the roof assembly 213. The secondary front-end panel is supported by a secondary front-end frame which is comprised of a secondary top front-end rail, a secondary bottom front-end rail, and a second pair of front-end posts.

A secondary roof compartment 201 can be defined by the roof assembly of the shipping container 213, a secondary roof assembly 214, the front-end panel 215, the cargo-access doors 208, the road-side panel 219, and the curb-side panel 223. The secondary roof assembly 214 is supported by a secondary roof frame which is comprised of an intermediate curb-side rail, an intermediate road-side rail, an intermediate front-end rail, and an intermediate cargo-access rail. The secondary roof frame is attached to the roof assembly 213 of the shipping container and the secondary roof assembly 214, in one embodiment.

Electrical connections 204, 205 mounted on a connection plate 206 are placed along or within the frame of the rechargeable shipping container which permits the transmission of power between the internal compartment of the rechargeable shipping container and an external connection. In another embodiment of the invention, the corner fittings of the container are modified to include an electrical outlet, which may also be configured to automatically enable the containers' electrical connections with each other when the containers are arranged or stacked together. None of these modifications modifies the external dimensions of the rechargeable shipping container keeping the container within ISO standards

In some configurations, separate power conduits within the frame of the rechargeable shipping container may be required. The configuration shown in FIG. 2 may not require separate power conduits as the secondary compartments housing the rechargeable batteries can provide a path for wiring to electrically couple the rechargeable batteries to each other as well as to electrical outlets on the external surface of the container. The need for separate power conduits will depend on the particular configuration of the secondary compartments as well as placement of the electrical outlets.

The secondary compartments housing rechargeable batteries can be configured in several ways by including one or more of the secondary compartments described above. For example, other embodiments can comprise a rechargeable shipping container with only a single secondary compartment. In one such embodiment, the primary compartment is defined by the secondary flooring of the shipping container, the road-side panel, the curb-side panel, the front-end panel, cargo-access doors, and the roof panel assembly. The secondary compartment is defined by the bottom flooring of the shipping container, the road-side panel, the curb-side panel, the front-end panel, the cargo-access doors, and a secondary flooring.

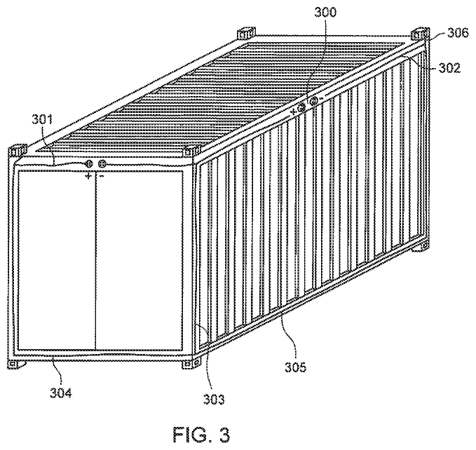

In the embodiment shown in FIG. 3, power conduits placed within the frame of the container, including the posts or rails, carry electrical wiring 301, 302, 303, 304, 305, 306 to couple the rechargeable batteries with the electrical outlets 300. These outlets will be used to connect a rechargeable shipping container to another container, power drive system, or charging station. These outlets can be installed in numerous locations on the container provided there is a protected pathway for wiring to electrically connect the outlets to the onboard batteries. Multiple electrical outlets may be installed on one rechargeable shipping container with each outlet electrically coupled to every other outlet.

For example, FIG. 3 depicts one embodiment of the invention with power outlets 300 located on the top curb-side and cargo-access rails. Outlets could additionally be placed along the top road-side and front-end rails. Outlets in this configuration would permit more flexibility for placement and orientation of the rechargeable shipping container while ensuring that an electrical outlet is still accessible for connection. Power outlets could also be placed along both top and bottom rails on side of the container. Such a configuration would permit shorter or even no cabling to be used for containers that are vertically stacked as the bottom rail outlets of the higher container will be in close proximity to the top rail outlets of the lower container. For embodiments where no cabling is needed (not shown), the power outlets of each container are configured to be in contact with the power outlets of adjacent containers when they are stacked on top of or next to each other. Power outlets can be installed in any combination of the above configurations or other configurations as needed for the particular application of the rechargeable shipping container. For example, as described above, outlets can be integrated into the corner fittings, which can allow automatic electric connections to other containers when they are stacked together either vertically or horizontally, or to charging stations or other means (e.g., electrical outlets of a ship or a chassis on which the containers are placed).

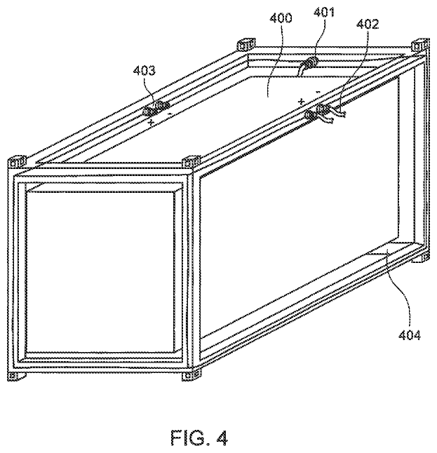

In another embodiment of the invention, the rechargeable shipping container comprises an ISO standard container with only a single compartment containing rechargeable batteries 400 which will provide power to the ship, or any other types of vehicles carrying the container (e.g., a train), as shown in FIG. 4. In this configuration, the container does not have separate compartments for holding cargo and functions only as a power source for an electrical container ship. The compartment housing the batteries is shielded from the area external to the rechargeable shipping container. Nonetheless, the shipping container containing the batteries may still be provided with ventilations (e.g., openings to outside) so that the batteries can be provided with cooling. Such ventilation may be designed so as to protect the batteries from elements that may damage the batteries when directly exposed to such elements. An electrical connection is provided from the battery pack to the power conduits 401 within the posts or rails to electrically couple the batteries 400 to the electrical outlets 402, 403 of the rechargeable shipping container. A designated area 404 on the inside of the container is adapted to removably receive a removable package of sensors for the batteries 400. The designated area 404 may also be equipped with processors the container so that they may be individually identified and managed from a central computer interface. The designated area 404 is accessible from a panel on the exterior of the container, in one embodiment. In one embodiment, the designated area is accessible from a side panel of the container, obviating the need to open the cargo door to access consumable components in the designated area 404.

Another advantage of the rechargeable shipping container is that it provides and stores power in the form of electrical potential which allows for greater versatility in recharging the onboard batteries. While the most common method of recharging the batteries will be to connect the container to a charging station when an electric container ship is docked, other methods can be utilized while the ship is docked but also while the ship is in transport. Natural, renewable sources of energy that are available to a container ship in transport can be tapped to supplement the power available in the batteries, extending the power capacity of the batteries and also lowering energy costs.

In one embodiment of the invention, the rechargeable shipping container provides for a solar panel affixed to the external side of the roof-assembly of the shipping container. The solar panel is made up of photo-voltaic cells 502 which convert sunlight to electrical energy. This energy can be used to recharge the batteries on board the shipping container, while the container is loaded on a ship or after it has been unloaded from the cargo ship. In this embodiment, the solar panel lays flat parallel to the roof assembly and extends vertically from the external side of the container to a point below the highest vertical point of the corner fittings of the container. This configuration will protect the solar panels if other containers are stacked vertically on top of the solar rechargeable shipping container.

As used herein, a solar panel refers to not only the photovoltaic cells mounted on a substrate, but also refers to all ancillary equipment. For example, in most embodiments, the solar panel includes a control circuit, an inverter, and other necessary components to transfer electricity from the photovoltaic cells to the battery packs. Even in instances where the solar panels are coupled to a DC load and conversion to AC is not desirable, a control circuit is in place to prevent attempts to draw excess current from the panels. In some embodiments, the solar panels also include a solar concentrator. In most embodiments, the solar panel includes at least one array of photovoltaic cells suitably interconnected to facilitate maximum power draw. The solar panel also includes interconnects, such as the industry standard MC4 connector.

In some embodiments, the solar panels include built-in systems to detect and address soiling. For example, in some embodiments, the panels are reoriented so as to dislodge any dirt or other light-obscuring material from the surface of the panels.

The solar panel on the external side of the rechargeable shipping container is electrically connected to the batteries within a secondary compartment of the container via an aperture on the top side of the container. The aperture permits an insulated conduit containing electrical wiring which carries power from the solar panel to the batteries. The point of contact between the aperture and the power conduit will be sealed with a gasket such as an O-ring to shield the conduit from external elements such as water and other contaminants.

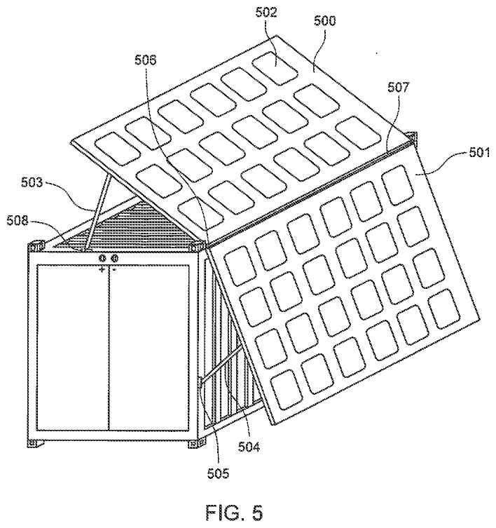

In another embodiment of the invention, solar panels 500, 501 are affixed parallel to the external side of the roof-assembly, as well as the road-side or curb-side of the shipping container. A rectangular solar panel within the perimeter of the panel of the container it is mounted to can be used. To increase the exposure of the solar panels to sunlight, the solar panels can be raised as shown in FIG. 5. Each solar panel is mounted on hinges 506 on one side along the length of the panel. Struts 503, 504 may be gas struts and are affixed to the underside of the solar panels and an external side of the shipping container. The struts are ideally placed in line with the hinges 506 across the width of the panel and at a point between the center of the width of the panel and the unhinged edge of the panel 505, 508.

When the containers are unloaded from a cargo ship, the solar panels can be lifted so they rotate about a longitudinal axis 507 on the hinged side of the solar panel to gain more direct exposure to sunlight as shown in FIG. 5. When loaded onto a cargo ship, the solar panels can be raised if sufficient clearance is provided within the container stack. For example, a container on top of a container stack could raise the solar panel installed on the roof. If sufficient clearance is available on a container placed on the permitter of a container stack, that container's side solar panel can be raised.

In case of gas struts, pressured gas within the cylinders of the struts bears the majority of the weight of the solar panel allowing the panel to be raised more easily. Hinges can be installed on either side of the solar panel affixed to the roof assembly of the shipping container. The container can be placed on the ship with the hinged side of the roof-assembly solar panel facing the side of the ship that will receive more solar energy along the shipping route of the ship. The hinges of a solar panel affixed to the road-side or curb-side of the container can be placed on the longitudinal axis 507 of the solar panel closest to the roof assembly along the length of the container.

The road-side or curb-side solar panels can then be raised from the longitudinal edge of the solar panel closest to the bottom of the shipping container. Each solar panel can be returned to a position where the underside face of the panel rests parallel to the external panel of the roof-assembly, curb-side, or road-side of the shipping container, by applying an upward force to the non-hinged side of each panel towards the shipping container.

In another embodiment of the invention, solar panels are placed on the curb-side, road-side, or front-end of the rechargeable shipping container. In this embodiment, the curb-side, road-side, and front-end panels of the rechargeable shipping container consist of corrugated panels. The solar panels are then placed within the indented areas of the corrugated panels. Such a configuration protects the panels from direct impacts if the rechargeable shipping container collides with another container, or any other object, particularly during load and unloading.

In another embodiment of the invention, the rechargeable shipping container provides for an alternative rechargeable power source such as a hydrogen fuel cell system to be placed within the shipping container. The alternative rechargeable power source can be used to charge the batteries within the secondary compartment while the container is in transit aboard an electrical cargo ship or provide power directly to the power system of the cargo ship.

The rechargeable shipping container will be shielded from the area external to the rechargeable shipping container. Such shielding ensures that the environment of the compartment housing the batteries remains within the required environmental specifications required for the batteries to continue to operate efficiently. This includes shielding from elements such as moisture, water, or other contaminants as well as shielding from any electrical interference that may be caused by the cargo held within the primary compartments or any source of interference external to the shipping container. However, like described above, the shipping container containing the batteries may still be provided with ventilations (e.g., for cooling) so long as such ventilations are designed to protect the batteries from environmental elements that may damage the batteries when directly exposed

The batteries contained within the rechargeable shipping container can be electrically coupled to electrical contact points on the external frame of the container by accessing any of the power conduits that are placed within the bottom flooring frame portion, the roof frame portion having the power conduits 401, or the four corner posts of the container. In embodiments with one or more secondary compartments, regardless of the positioning of the secondary compartments, the secondary compartments are also shielded from the primary compartment 200.

Depending on operational conditions and requirements, the rechargeable shipping container may contain an onboard cooling system as well as a battery management system. The battery management system can include a thermal management system, a monitoring system, and a load balancing system. The thermal management system attempts to keep the temperature of the batteries within an optimum operating range which will vary depending on the type and configuration of the batteries and the electrical load being driven by the batteries. The thermal management system can include passive and active elements. Passive thermal management relies on thermally conductive materials which conduct heat from the batteries to the external area of the rechargeable shipping container. Active thermal management elements can include standard cooling methods including liquid or air cooling which are applied in response to a rise in temperature detected by the monitoring system.

The monitoring system monitors performance metrics of the batteries including voltage, current flow, temperature, operating time, and also provides a means to remotely track and operate each of the monitored containers containing the batteries. This information is transmitted via data cables within the power conduits of the rechargeable shipping container to monitoring systems on the electric cargo ship. As multiple rechargeable containers can be electrically coupled to one another, a communication bus standard such as a Controller Area Network bus (such as CAN 2.0B) to manage information transmitted from multiple containers to monitoring systems.

The performance of individual cells within the battery can vary depending on several factors such as individual cell capacity, charge and discharge performance, and degradation. As a result, some battery cells may be depleted at a much faster rate than other cells. This can lead to the voltage of the battery falling below minimum operating requirements despite charge remaining within the battery. By monitoring the voltage of each individual cell, the load balancing system can vary the current drawn from each individual cell to optimize the overall performance of the battery.

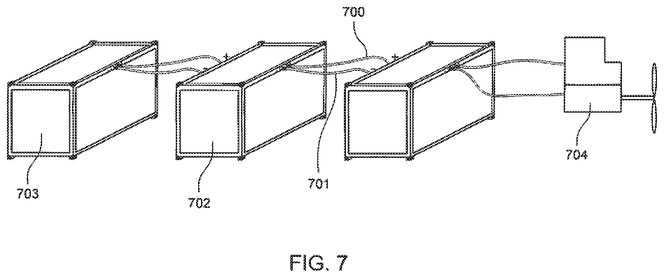

One aspect of the invention which improves the efficiency and ease of replenishing the power supply of an electric container ship is the ability of each rechargeable shipping container to be electrically coupled to one or more other rechargeable shipping containers. By connecting the containers in parallel as shown in FIG. 7, the current and power capacity of the electric container ship's power source can be increased without affecting the operating voltage of the ship. Electrical contact points may be placed along the frame of the rechargeable shipping container and electrically coupled to rechargeable batteries within the secondary compartments of the rechargeable shipping container via the power conduits in the bottom flooring frame portion, the roof frame portion, or four corner posts.

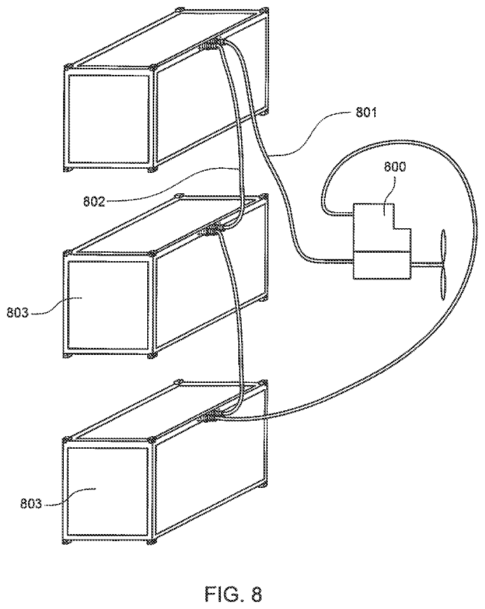

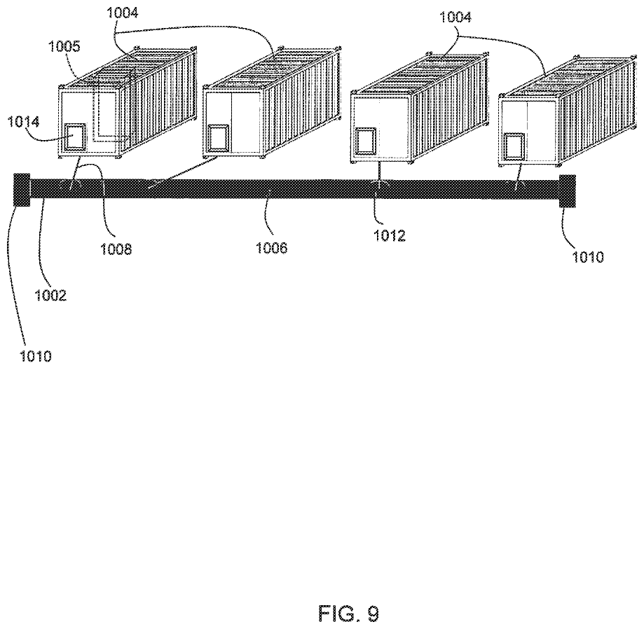

The rechargeable shipping container may also be connected in series to other rechargeable shipping containers as shown in FIG. 8. Although rechargeable shipping containers with any configuration can be connected in series, a series connection is most preferable for the embodiment of the invention of a rechargeable shipping container containing only a primary compartment 200 for housing batteries. As connecting the containers in series will increase the amount of voltage, a specific number of containers will be required to achieve the requisite voltage required by the electric cargo ship. This configuration of the rechargeable shipping container provides significantly more current capacity than the hybrid configuration with primary and secondary compartments. Consequently, significantly fewer rechargeable shipping containers will be needed to meet the power requirements of the ship, making it easier to manage the containers needed to provide the requisite voltage as well.

The rechargeable shipping containers can also be connected in a mixed configuration where some containers are connected in series, and some are connected in parallel. By connecting a specific number of rechargeable shipping containers in series to form a set of rechargeable shipping containers, the requisite voltage required by an electric cargo ship can be achieved. Additional sets of rechargeable shipping containers can be connected in series to provide the same level of voltage. These sets can then be connected in parallel to increase the total power capacity of the rechargeable shipping containers.

While a number of different physical configurations can be used for the electrical outlets, the use of water-tight reefer plugs to electrically couple one rechargeable shipping container to another rechargeable shipping container can provide some advantages. Reefer plugs such as those manufactured by ESL Power Systems of Corona, CA, are commonly used in the transport and cargo industry to provide power to shipping containers such as refrigerated shipping containers. Water-tight reefer plugs provide for high voltage electrical connections and sufficient shielding to protect those connections from external elements.

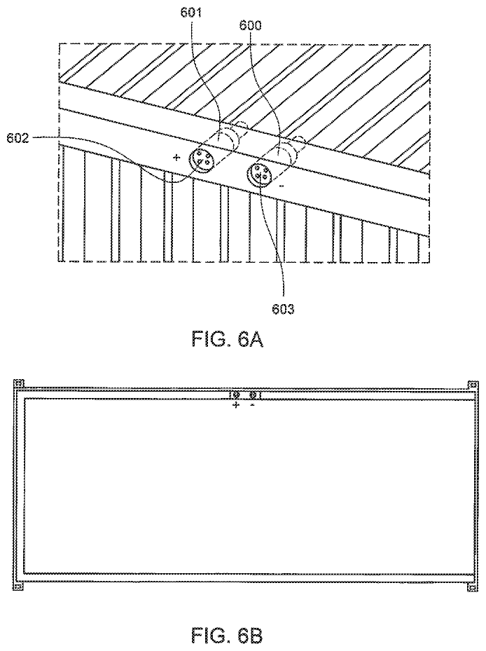

Pairs of reefer plugs can be installed along the external frame to provide electrical positive 602 and negative 603 terminals on either side of the containers as shown in FIG. 6A. The availability of both terminals will allow the containers to be connected to other containers in a variety of configurations, as described herein. The reefer plugs are placed with the proximal end of the plugs facing away from the container 600, 601. The reefer plugs are installed such that the proximal end of the plug is flush with the external sides of the rechargeable shipping container as shown in FIG. 6B. Thus, the container will preserve its external dimensions keeping it within ISO standards.

The distal end of the reefer plug is inserted into the rechargeable shipping container via an aperture at the point of installation. This will allow the reefer plugs to be electrically coupled to the power conduit located within the frame of the rechargeable shipping container. The aperture will be sealed against the circumference of the distal end with a gasket such as an O-ring to shield the electrical connection from external elements. Although the reefer plugs can be placed anywhere along the frame, placing the reefer plugs at the midpoint along length L and along the width W of the rechargeable shipping container will facilitate alignment of reefer plugs on multiple containers.

Once the rechargeable shipping containers are loaded onto an electrical cargo ship, reefer plug cables 700, 801, 802 can be used to electrically couple the rechargeable shipping containers together and with a motor 704, 800 which in turn can be mechanically coupled to the ship's source of movement, such as a propeller. The use of a flexible cable to electrically connect rechargeable shipping containers together permits the containers to be connected regardless of whether they are placed horizontally next to each other 702, 703 or stacked vertically on top of one another 803. However, the connections can happen without using cables by, for example, coupling the outlets integrated into corner fittings of the containers as described above and further below.

In another embodiment, the electrical contact points of each rechargeable shipping container will be integrated into the corner fittings of a standard ISO shipping container. Each of the eight (8) corner fittings of a container, comprises a set of apertures. In one embodiment, a top corner fitting has three apertures, while a bottom corner fitting has two apertures each. Shipping containers can be physically coupled to one another by the use of interlocks such as twist locks, cones, or lashing bars, or other mechanisms. Each corner fitting interlock is horizontally oriented with one corner fitting interlock being parallel to the length L and the second corner fitting interlock being parallel to the width W. The corner fitting interlocks are used to secure the shipping container to an adjacently located, second shipping container using a securing pin or similar fastener.

The surface of the electrical contacts could be constructed of highly conductive metals or alloys of metals such as nickel, copper, silver, aluminum, gold, steel, cadmium, or brass. The contacts can be electroplated with other materials such as gold, aluminum, copper, or silver to improve conductivity depending on the power requirements of the application. The corner fittings of a rechargeable shipping container contain electrical contact points within each aperture of each corner fitting. A corner fitting from one rechargeable shipping container can be coupled to a corner fitting of another rechargeable shipping container by using an interlock containing electrical contact points which form electrical connections with the electrical contact points of the corner fittings of a container.

There are numerous other known methods of connecting two or more power sources. Any mechanism that satisfies the electrical requirements for the specific application, shields the connection from external elements, and does not violate the ISO standards for shipping containers, can be used to electrically couple one rechargeable shipping container to another. For example, if wireless power transmission can meet the voltage and current requirements, rechargeable shipping containers could be fitted with wireless power transmission nodes that connect to one other.

Although shipping containers are most commonly used on cargo container ships, they often are transported using several different vehicles during the course of their journey. For example, container trucks or trains often transport shipping containers to loading docks and are then loaded onto cargo ships. Once the cargo ship reaches its port of destination, these containers are offloaded from the ship and often loaded onto trains or container trucks to reach their final destination. One advantage of the invention is that the integration of a power source within the shipping containers means that power capacity is seamlessly transferred along with the container itself. Just as the rechargeable shipping container can provide power to an electric container ship, it can provide a power supply to an electric container truck. Similarly, one or more rechargeable shipping containers can be loaded onto an electrically powered train and connected in parallel via an electrical conduit within the coupling mechanisms of each railcar. A rechargeable shipping container could also supply power to an electrically-powered aircraft that is used to transport the container.

Another advantage of the invention is that the portability of rechargeable shipping containers provides for low-cost and simple transport of supplemental power to stationary structures such as buildings, houses, or temporary shelters. Such an application of the invention can be particularly useful in rural areas, disaster areas, or any other location that requires significant amounts of power on a temporary basis. Although any type of configuration of the rechargeable shipping container can be used in such applications, the configuration of a container with only a primary compartment housing rechargeable batteries, as shown in FIG. 4, may be best suited for such applications.

The rechargeable shipping container would preferably be designed to adhere to ISO standards of shipping containers. However, the novel rechargeable shipping container which can be recharged and supply power to numerous electric vehicles or locations while simultaneously transporting goods could be utilized in a non-standard configuration where a shipping container is not required to adhere to ISO standards.

FIGS. 7 and 8 show the batteries connected in series or in parallel, using direct connections, such as cables 701, 801. Turning to FIG. 9, depicted therein is a schematic of a customized cable 1002 which connects the containers 1004 which include batteries, such as the battery modules 1005, to a central cable bus 1006. The containers 1004 can be connected in series or in parallel as the individual connections 1008 are shown in schematic form as a single line. The central cable bus 1006 includes terminals 1010 which can be connected to other power sources, such as being linked to another set of containers 1004.

While the containers 1004 are shown on a single horizontal line, the cable 1002 can interconnect the containers 1004 either while they are horizontally or vertically connected. In one embodiment, the tap points 1012 can be arbitrarily selected along the length of the cable bus 1006. For example, in one embodiment, the cable bus 1006 includes a pliable insulation and the tap points 1012 can be inserted through the insulation to the conductors within the cable bus 1006 akin to a piercing tap. In other embodiments, the cable bus 1006 comprises interconnected modules and the tap points 1012 can be added as a module.

Each container 1004 includes a status panel 1014 showing information about the type of battery technology used in the battery module 1005 as well its performance characteristics, such as amount of power being drawn, the temperature of the battery module 1005 and other relevant information. In one embodiment, the status panel 1014 includes an electrochemical display, for example showing the temperature using a temperature-responsive strip.

A benefit of embodiments described above is that batteries can be swapped while the vehicle is in route. For example, when used for a ship that is nearing a port, charged batteries may be provided to the ship via a local barge even before the ship enters the congested port. Battery swaps can occur without having the ship enter into a port capable of handling all of the containers on the ship. Instead, battery swaps occur at much smaller ports or even on waypoints such as an artificial island which obtains power from a power source that cannot be constructively used for another purpose.

In some embodiments, battery swaps can occur while the ship is moving or otherwise staying on the high seas and not in a port. In such instances, while still in the ocean, an electric-powered ship is met by a ship having charged container batteries. The two then swap containers, in one embodiment, or the electric-powered ship receives additional batteries.

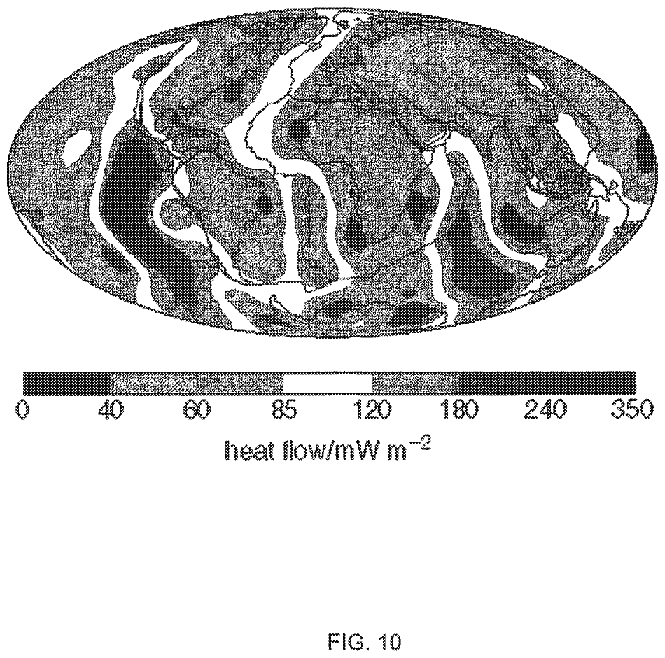

As shown in FIG. 10, many geothermal gradients that can be used for geothermal power occur off-shore and away from population centers. Such power sources could be used by a ship traversing the ocean, stopping at an off-shore platform to replace battery packs.

Another benefit of the use of battery swap technology is that it creates a local economy for both energy generation and power storage as well as energy export. Many smaller islands chains near the equator can benefit from improved power infrastructure that would support the recharging stations for the container-based batteries.

Each individual container, such as the containers 1004 shown in FIG. 9 employs a different battery technology. For example, in one embodiment, the types of batteries included in the container could be a small modular reactor for fuel cells, a regenerative ammonia battery, a methanol fuel cell, liquid-metal battery, liquid electrolyte flow battery, a solid-state battery, and vanadium redox battery. A benefit of the use of the containers 1004 is that large tanks can be used to maximize energy storage. Many types of batteries, such as the flow batteries improve performance if the storage tanks can be made larger.

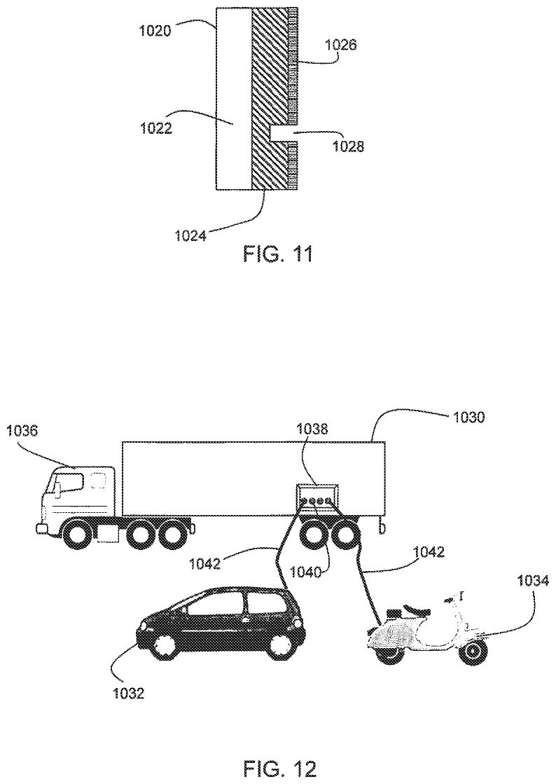

FIG. 11 shows a cross-section of the wall 1020 of one of the containers 1004 shown in FIG. 9. The wall 1020 includes an external layer 1022 to which an insulation layer 1024 is attached. A finish layer 1026 is added to the insulation layer 1024, in the depicted embodiment. At appropriate locations, indentations 1028 are defined in the finish layer 1026, providing channels for wiring or providing locations for mounting hardware for secure attachment of battery modules. The cross section shown in FIG. 11 shows the thicknesses of the layers only for clarity and is not intended to be limiting. For example, in some embodiments the finish layer 1026 comprises a layer of paint and so it is exceedingly thin. In other embodiments, the finish layer 1026 comprises a fire retardant material and so is that much thicker. The external layer 1022 comprises the steel elements of the container, in one embodiment. In at least some embodiments, the external layer 1022 is also covered by a weatherproof coating (not shown).

In some embodiments, insulation material is placed specifically between the batteries and the cargo (e.g., a separate insulation wall or the secondary frame itself can be made of insulation materials) that can protect the cargo from the heat generated by the batteries.

In one embodiment, the indentations 1028 are used for a thermal management system. For example, a series of convection directing channels will move air around the battery modules, using the indentations 1028. In another embodiment, coolant lines are installed in the indentations 1028 or on the finish layer 1026 and the coolant lines are connected to the battery modules to facilitate heat exchange.

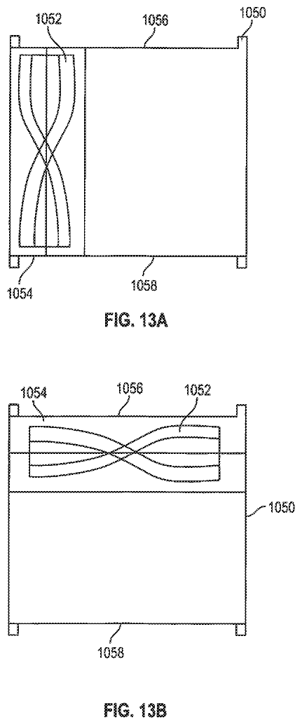

The use of one embodiment is shown in FIG. 12. In this embodiment, a container 1030 having internal batteries (not shown) is used as a portable power source for electric or hybrid-electric vehicles such as a car 1032 (including an electric car or a hybrid car) or a scooter 1034. Other potential recipient devices could be a portable light, an electric bicycle, a water pump or filtration system, and many other applications. The container 1030 is conveyed to a charging location by a truck 1036 or by another suitable mode of transportation such as a train (not shown). In many locations, disused train tracks can be used to convey charging containers 1030. The container 1030 includes an access panel 1038 which includes appropriate control circuits (not shown) to allow for standard receptacles 1040 to be defined on the access panel. The size of the receptacles 1040 are not to scale and are shown larger. The vehicles connect to the receptacles 1040 using charging cables 1042.

In another use of the embodiment (not directly shown), the container with internal batteries is used as a portable power source for a desalinization plant on board of a container ship. In this embodiment, the vessel's fresh water needs can be met by a desalinization plant on-board. In another embodiment, the desalinization plant is of a larger scale and can provide fresh water not simply for consumption on board the vessel, but also to third party users, such as residents in a port area without access to fresh water. In another embodiment, the vessel uses excess power generated from solar panels to generate fresh water. In yet another embodiment, the salt-water brine is used as a medium for batteries used by the container. A benefit of this system is that fresh water can be generated in locations without reliable power (such as in a region recovering from a disaster) without dumping large amounts of brine in the local ecosystem.

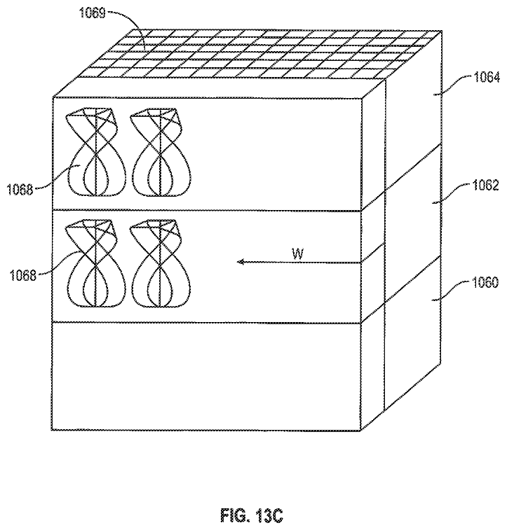

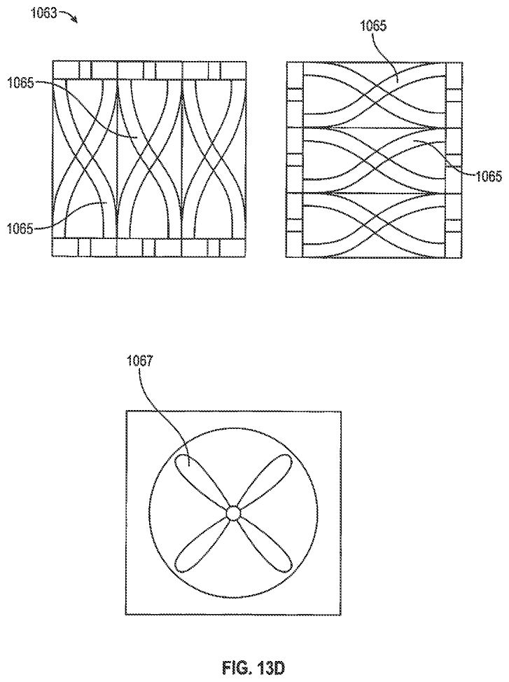

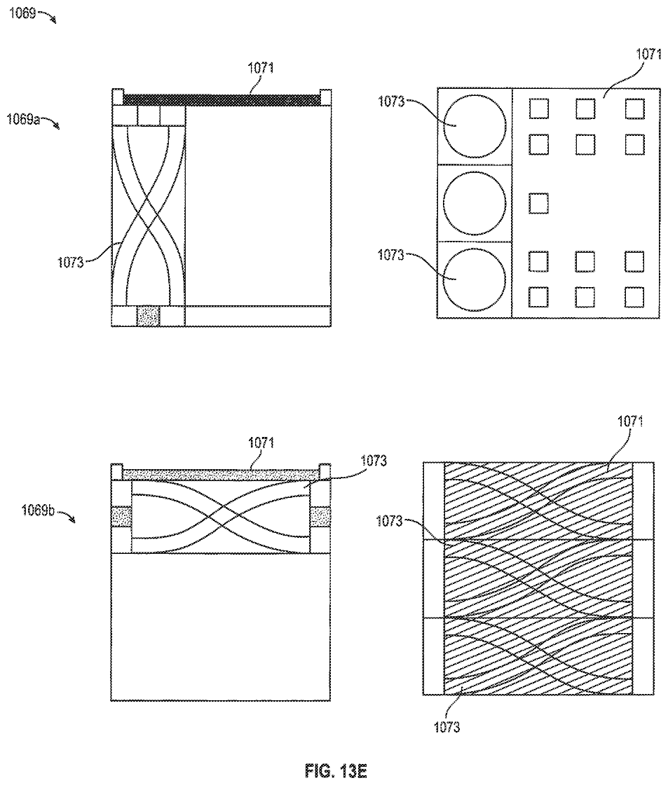

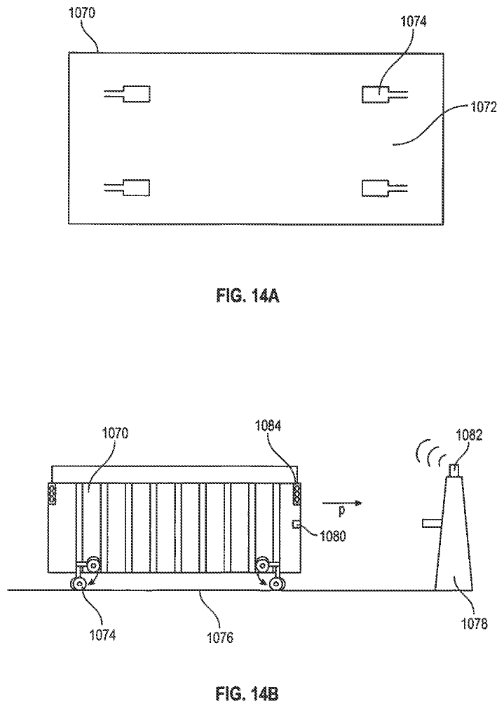

FIGS. 13A and B depict embodiments of a container 1050 with one or more wind turbines 1052 defined within a recess 1054 in the container 1050. The recess may be perpendicular to the top 1056 and bottom 1058 of the container 1050, as shown in FIG. 13A or it may be parallel with the top 1056 and the bottom 1058, as shown in FIG. 13B, or it may be oriented arbitrarily. However, a vertical or horizontal orientation is preferred as it maximizes the remaining available storage in the container. In one embodiment, the remaining storage space in the container 1050 is used for batteries. In another embodiment, the remaining storage is used for cargo. While the containers 1050 shown in FIGS. 13A and 13B are depicted as having single turbines, multiple turbines may be included in the containers. FIG. 13C shows a set of containers 1060, 1062, 1064 assembled on a vessel. Depending on a container's location within a stack of containers, the most effective orientation of the wind turbines may differ. For example, the lowest containers 1060, which can be near the deck level, may benefit from wind turbines that are oriented differently from containers that are located higher in the container stack because of the different exposure to the wind (shown as arrow w) due to the containers' location. Accordingly, the middle containers 1062 may include multiple wind turbines 1068, and the topmost containers 1064 may include wind turbines. Some containers include a combination of wind turbine 1068 and containers 1069 including a solar panel. However, regardless of placement, the containers will benefit from including at least one turbine, by for example, providing additional cooling for battery packs.

FIG. 13D depicts schematic views of containers 1063 which include only power sources 1065. In the embodiments shown in FIG. 13D, the power sources are one or more wind turbines 1065. In some embodiments, multiple wind turbines 1065 are arranged in the container 1063. In other embodiments, a single turbine 1067 is installed in the container 1063. The container which includes only power sources 1063 is used to generate power while the vessel is in transit. The container 1063 distributes power to the vessel or to other containers on-board that include batteries. A benefit of the container 1063 is that it will be lighter than other containers that include batteries or cargo as well as power generators.

In some embodiments, a generator can be used as another form of generating electricity to power the batteries (which in turn power the electric motor) in addition to solar panels, wind turbines, geothermal, etc. For example, after the container batteries have collectively dropped to a predetermined threshold from full charge, a gasoline or diesel fueled internal combustion engine (or a group of such engines) can power a generator (or a group of generators) to extend the range of the ship or any vehicles that are powered by the container batteries. Such a generator may also be fueled by natural gas (e.g., from an LPG- or LNG-tank), ethanol, or any other conventional fuels that can be easily stored onboard like traditional or conventional vehicles. Such generators can be used as back-up sources of electricity when the container batteries are depleted or in the process of being depleted. The electrical power from the generator can be sent primarily to the electric motor, with the excess going to the batteries, depending on the state of charge of the battery packs and the power demanded at the motor.

When the batteries reach their minimum charge, the combustion engine is triggered. The engine drives the secondary motor as a generator, via the charging electronics, to keep the minimum battery charge level. Thus, the container batteries can permit the vehicle to operate as a pure battery electric vehicle until its battery capacity has been depleted to a defined level. Then, as described, it can start operating as a series hybrid design where the gasoline engine drives the generator, which keeps the battery at or above minimum level charge and provides power to the electric motors.

FIG. 13E depicts two example embodiments of a container 1069 with both a top 1071 area suitable for solar panel cells and at least one wind turbine 1073 combined with an area suitable for cargo or a battery (not depicted). In the first type 1069a, the turbines 1073 are oriented substantially perpendicularly with respect to the top 1071 of the container. As shown in the top view of the first type, the wind turbines 1073 comprise a column of vertically arranged turbines with the remaining area of the container 1069 used for battery storage. In the second type 1069b, the turbines 1073 are oriented substantially parallel with the top of the container 1069. As visible in the top view of the second type, the turbines 1073 form a row in the top portion of the container 1069 with the remaining internal area used for battery storage or cargo storage. A solar panel covers the top 1071 of the container 1069.

A benefit of combinations of wind turbines with batteries contained in the same structure such as container 1069 is that the air movement created by the turbines will cool off the container 1069 with the batteries. In one embodiment, the walls of the container 1069 battery compartment include heat dissipating fins to facilitate heat exchange between the battery compartment and the turbines.

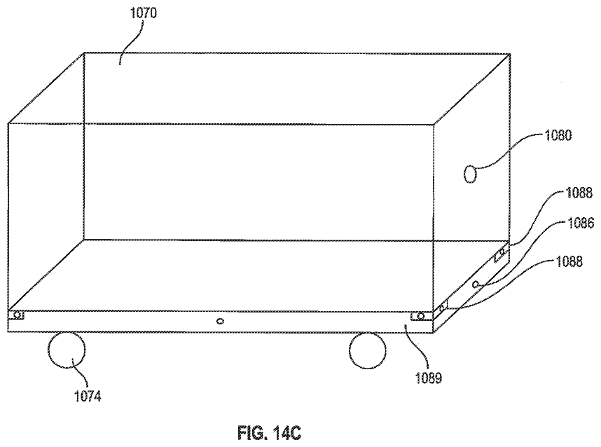

FIGS. 14A and 14B show the details of retractable wheels which are used in one embodiment of the container 1070. As shown in the bottom view of FIG. 14A, the wheels 1074 are normally retracted into the container 1070 beyond the plane formed by the container bottom 1072. As shown in FIG. 14B, the wheels 1074 deploy when the container is near a travel surface 1076. The container 1070 then conveys, using its wheels 1074 on the surface 1076, to its destination, such as a charging station 1078. To guide the alignment of the container 1070 charging port 1080 with the charging station 1078, a signal generator 1082 is provided on the charging station 1078 and a suitable receiver 1084 is defined on the container 1070. In one embodiment, the signal generator 1082 comprises an infrared generator. In one embodiment, the container 1070 also includes a satellite geolocation signal receiver and is provided with the geolocation of the charging station 1078 and is therefore able to plot a path (depicted by arrow p) to the charging station 1078. In at least some embodiments, the container 1070 operates in an autonomous self-charging mode, as shown in FIG. 14C. The container 1070 includes a computer or other controller with necessary sensors including audiovisual sensors 1086 and other sensors 1088 such as cliff sensors, bump sensors, wall sensors, and encoders for its wheels 1074. The sensors 1088 ensure alignment of the charging port 1080 with the charging station (not shown). The computer can then control the movement of the wheels as well as acceleration and braking of the container 1070. In one embodiment, the logic control of the container 1070 is handled by a computer in communication with the container 1070 wheels 1074 and not by a computer on-board of the container 1070. In another embodiment, the computer on the container 1070 is programmed to manage charge and discharge of batteries while the container 1070 is stationary and control the movement of the container 1070 when the container is in-port.

In one embodiment, the wheels 1074 and the autonomous movement logic is provided on a base 1089 which conveys containers 1070 to their destination. As such, the container is not different from a standard container.

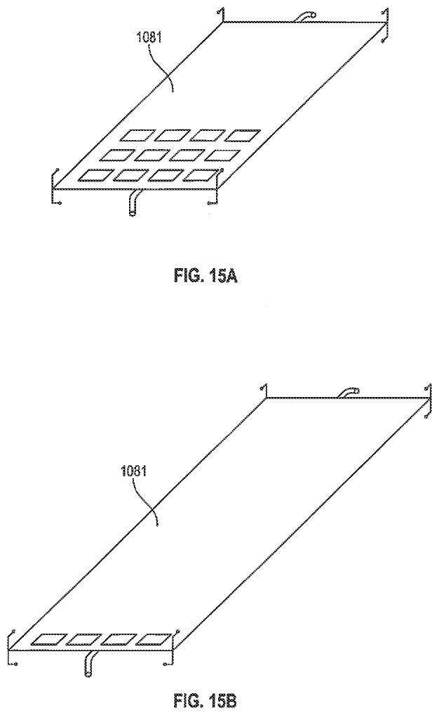

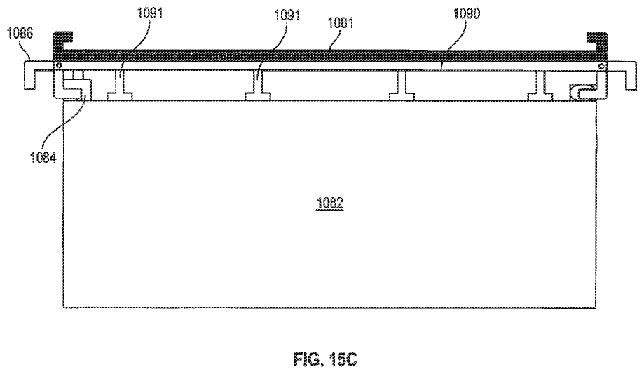

FIGS. 15A-15C depict a modular solar panel 1081 which can be attached to a container 1082. The modular solar panel 1081 attached to the standard corner fittings 1084 by engaging a locking arm 1086 with the corner fitting 1084. The corner fittings 1084 extend from the main frame of the container 1082. The locking arm 1086 has an open and closed configuration where it can hook on to the corner fitting 1084, in one embodiment. In another embodiment, the solar panel 1081 is locked on to the container 1082 with a screw, a twist lock, or similar fastener (not shown). The solar panel 1081 is affixed to a fixed frame 1090 which includes support legs 1091 and the locking arm 1086. The locking arm assembly 1086 is depicted in FIG. 15C as a suitable means of removably attaching the solar panel to the solar panel 1081 to the frame 1090.

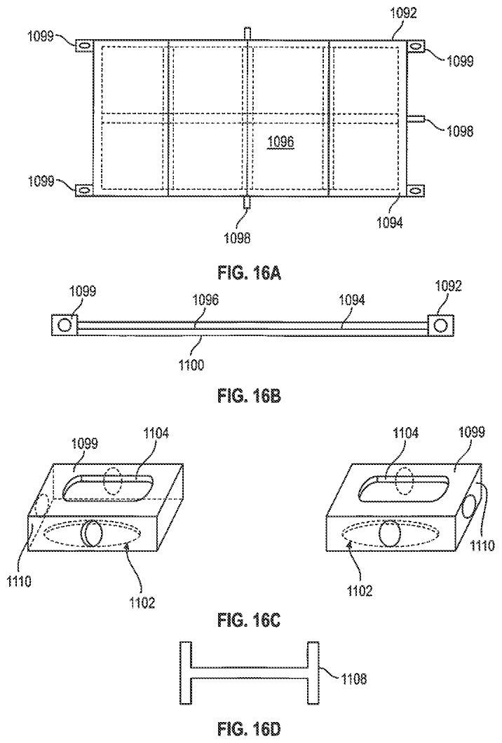

FIG. 16A shows a top view of a solar panel module 1092. The solar panel module 1092 comprises a base substrate 1094 having a lower surface 1100 and at least one solar panel 1096 connected to at least one electrical connection point 1098 on the solar panel 1096. As the connection point 1098 is on the solar panel 1096, the solar panel 1096 can act as a replaceable module that can be replaced as needed. The embodiment shown in FIG. 16A shows four connection points 1098, one on each side of the substantially rectangular base substrate 1094. Also, the connection points 1098 can be located on the base substrate 1094 (not shown) instead of protruding from it as shown in FIG. 16A. The base substrate 1094 includes module corner fittings 1099 which are designed to connect to the corner fittings a standard container (not shown). The module corner fittings 1099 are designed to removably attach to the container, as described below.

A side view of the solar panel module 1092 is shown in FIG. 16B. Visible from the side view is the thickness of the base substrate 1094, which is 40 mm in one embodiment. In one embodiment, the solar panel module 1092 is also 40 mm in thickness, except for the module corner fittings 1099 which are 118 mm tall.

FIG. 16C shows a detailed view of the module corner fitting 1099. As shown in FIG. 16A, the solar panel module 1092 has four corner fittings 1099. Each corner fitting has an additional bottom aperture 1102 unlike most standard container corner fittings. A top aperture 1104 of module corner fitting 1099 is adapted for use during lifting of the solar panel module. The bottom aperture 1102 of corner fitting is suitable to attach the solar panel module to the standard container located below with locking tools such as a twist lock. In one embodiment, the top aperture 1104 and the bottom aperture 1102 have a shape of a rectangle with rounded corners. This results in a twist lock 1108 having an I-Beam shape shown in FIG. 16D engaging with the sides 1110 of the fitting 1099 when rotated in place.

In one embodiment, different aperture configurations are used depending on whether a corner fitting is a top corner fitting (such as fitting 113 in FIG. 1) or a bottom corner fitting (such as fitting 114 in FIG. 1). For a top corner fitting, the top aperture 1104 is substantially rectangular and is adapted to be a stacking aperture. The side apertures of the top corner fitting are designed as the shield aperture and the stadium aperture. The shield apertures are aligned with the shorter sides of the container while the stadium aperture is aligned with the long sides of the container. For a bottom corner fitting, the stacking aperture is the bottom aperture 1102 instead of the top aperture 1104, which faces the post. In some embodiments, the top corner fittings do not include bottom aperture 1102 and the bottom corner fittings do not include the top aperture 1104.

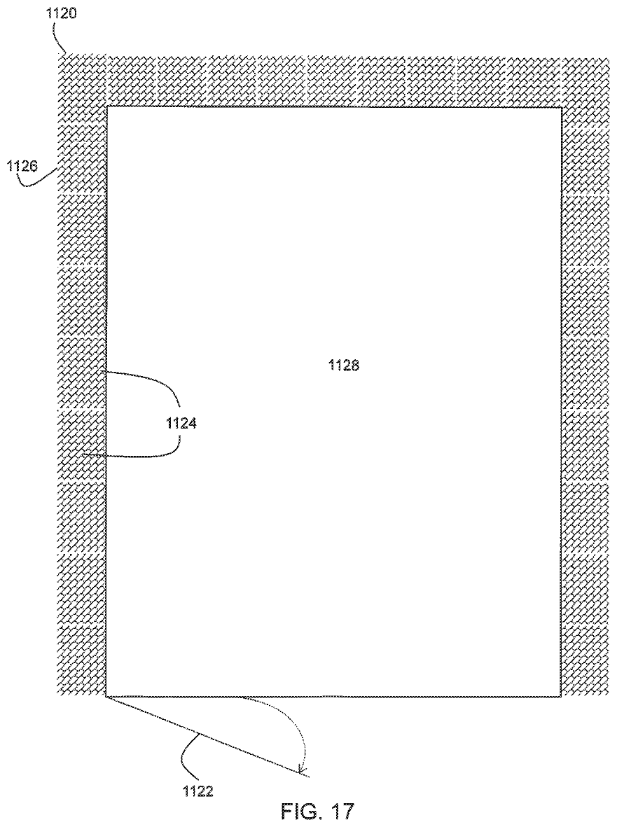

FIG. 17 is a top view of another embodiment of the container 1120 with a front door 1122. The container includes battery modules 1124 surrounding the interior walls 1126. In this way, the container 1120 includes internal storage space 1128 while providing for a multitude of battery modules 1124.

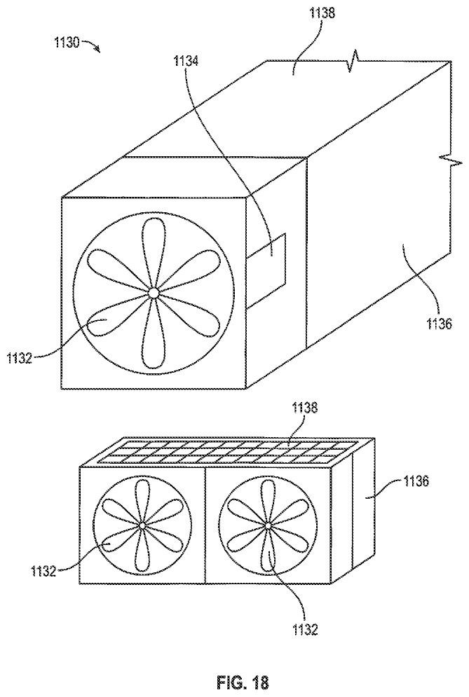

Another embodiment of container, a ship support container 1130 is shown in FIG. 18 which shows two types of the ship support container 1130. Each ship support container 1130 includes at least air movement device such as a fan 1132 coupled to a motor 1134. As shown in FIG. 18, the first type includes one fan 1132 while the second type includes two fans 1132. The motor 1134 is coupled to a battery 1136. The battery 1136, in turn is charged by a solar panel 1138, in one embodiment.

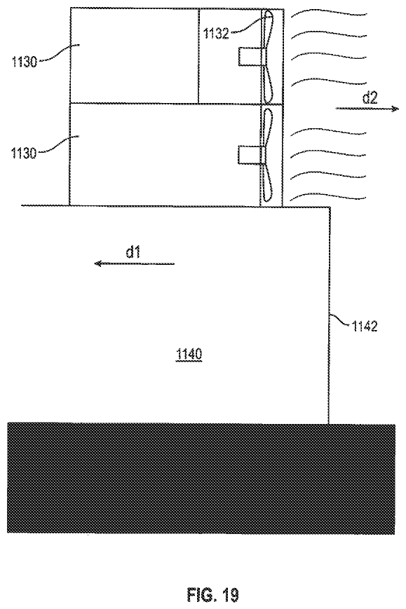

A side view of the ship support containers 1130 installed on a vessel 1140 is shown in FIG. 19. The vessel 1140 is moving in the direction d1. The ship support containers 1130 are attached to the vessel 1140 near its end 1142 such that the fans 1132 are blowing air in direction d2, which positively contributes to the vessel 1140 movement in direction d1. As can be appreciated from FIG. 19, the ship support containers 1130 can include storage space, batteries, or a combination of both.

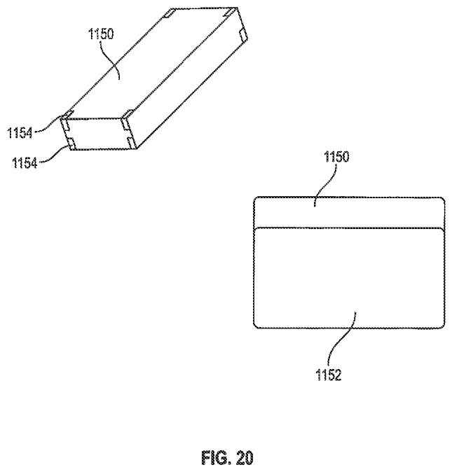

FIG. 20 shows another embodiment of the invention. In this embodiment, a supplemental battery 1150 can be coupled to a standard container 1152. The supplemental battery 1150 has the same width and length as a standard container 1152. The height of this supplemental battery 1150 is much lower, for example about 30 to 31 cm. The height of the supplemental battery 1150 height matches the height difference between a dry container's height and a high cube container height, in one embodiment. In one embodiment, the supplemental battery 1150 is expandable, for example by coupling additional supplemental battery modules (not shown). The supplemental battery 1150 has the same corner fittings 1154 as the containers discussed herein.

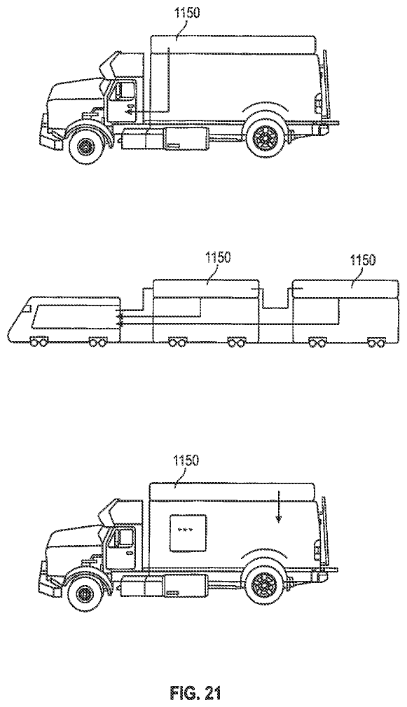

FIG. 21 shows some applications of the supplemental battery 1150, including on an electric truck, an electric train, and a refrigerated container. In these embodiments, the combination of the payload and supplemental battery 1150 does not exceed the height limitations of the truck.

In one embodiment, different types of supplemental batteries 1150 are used, depending on the application, each type having a different weight. For example, a heavier supplemental battery 1150 can be used on a train than on the back of a truck. As the energy storage medium density varies, so does the weight of the supplemental battery 1150.

The detailed embodiments of the present invention disclosed herein are merely exemplary of the invention that may be embodied in various and alternative forms. The figures are not necessarily to scale, and some features may be exaggerated or minimized to show details of particular embodiments, features, or elements. Specific structural and functional details, dimensions, or shapes disclosed herein are not limiting but serve as a basis for the claims and for teaching a person of ordinary skill in the art the described and claimed features of embodiments of the present invention. Many variations, combinations, modifications, or equivalents may be substituted for elements thereof without departing from the scope of the invention.

The above-detailed description is merely exemplary in nature and is not intended to limit the described embodiments or the application and uses of the described embodiments. Any implementation or embodiment described herein as “exemplary” or “illustrative”, or “representative”, is not necessarily to be construed as preferred or advantageous over other implementations. All of the implementations described above are exemplary implementations provided to enable persons skilled in the art to make or use the embodiments of the disclosure and are not intended to limit the scope of the disclosure, which is defined by the claims.

Furthermore, there is no intention to be bound by any expressed or implied theory presented in the preceding technical field, background, brief summary, or detailed description. It is also to be understood that the specific devices and processes illustrated in the attached drawings, and described in the specification, are simply exemplary embodiments of the inventive concepts defined in the appended claims. Hence, specific dimensions and other physical characteristics relating to the embodiments disclosed herein are not to be considered as limiting, unless the claims expressly state otherwise.

What is claimed is:

1. A container adapted to hold a power source, the container comprising:
a plurality of frame elements defining a plurality of corners and sides of the container, wherein the plurality of frame elements define an interior adapted for receiving the power source and an exterior disposed of in an environment in which the container is placed;
at least one power source located in the interior; and
a plurality of electrical connections provided on the exterior;
wherein said electrical connections provide for connectivity to the power source.

2. The container of claim 1, further comprising a primary compartment housed in the interior of the container wherein said primary compartment is defined by a secondary flooring, a secondary road-side panel, a secondary curb-side panel, a front-end panel, cargo-access doors, and a secondary roof assembly.

3. The container of claim 2, wherein said primary compartment is adapted to store cargo.

4. The container of claim 2, wherein the primary compartment is smaller than the interior of the container.

5. The container of claim 4, further comprising a secondary compartment surrounding the primary compartment.

6. The container of claim 5, wherein the secondary compartment is adapted to hold the at least one power source.

7. The container of claim 1, wherein said container comprises a shipping container.

8. The container of claim 1, wherein said frame elements comprise side panels, a container cargo-access end.

9. The container of claim 1, wherein the corners comprise eight corner posts for each corner of the container.

10. The container of claim 1, wherein the container is of a standard size and wherein the standard size is an ISO standard container size.

11. The container of claim 1, wherein the electrical connections are provided on a control panel mounted on the exterior of the container.

12. The container of claim 1, wherein at least one power source comprises a rechargeable power storage device.

13. The container of claim 12, wherein said power storage device comprises a modular reactor for fuel cells, a regenerative ammonia battery, a methanol fuel cell, a liquid-metal battery, a liquid electrolyte flow battery, a solid-state battery, and a vanadium redox battery, or a combination thereof.

14. The container of claim 1, further comprising a plurality of cables having plugs wherein said cables provide a connection between the container and a ship conveying the container.

15. The container of claim 14, wherein said connection between the container and the ship extends to a propulsion system operating in the ship.

16. The container of claim 1, further comprising at least one power source in electrical communication with the at least power source secured to the interior of the container.

17. The container of claim 16 wherein said power source comprises at least one solar panel mounted to an exterior of the container.

18. The container of claim 16, wherein said power source comprises at least one wind turbine and wherein opposing sides of said container is open to airflow from the exterior of the container to create motion in the at least one wind turbine.

19. The container of claim 1, further comprising a thermal management system.

20. The container of claim 19, wherein the thermal management system comprises a series of convection directing channels to move coolant around the at least one power source.

21. The container of claim 1, wherein said plurality of electrical connections is adapted to provide power from the at least one power source secured to the interior of the container to recipient devices.

22. The container of claim 21, wherein said recipient devices comprise an electric car, a scooter, an electric bicycle, and others.

23. A plurality of shipping containers in electrical communication, wherein each container comprises:
a plurality of frame elements defining a plurality of corners and sides of the container, wherein the plurality of frame elements define an interior adapted for receiving a power source and an exterior disposed of in an environment in which the container is placed;
at least one power source located in the interior; and
a plurality of electrical connections provided on the exterior;
wherein said electrical connections provide for connectivity to the power source.

24. The plurality of containers of claim 23, wherein individual containers comprising the plurality of containers are connected in series.

25. The plurality of containers of claim 24, wherein individual containers comprising the plurality of containers are connected in parallel.

26. The plurality of containers of claim 23, wherein the plurality of containers provide power to a vessel carrying the container.
